(19) United States
(12) Patent Application Publication
(10) Pub. No.: US 2023/0306502 A1
(43) Pub. Date: Sep. 28, 2023

(54) PRESENTATION CREATOR FOR SEQUENTIAL HISTORICAL EVENTS

(71) Applicant: Wells Fargo Bank, N.A., San Francisco, CA (US)

(72) Inventors: Gene C. Baker, JR., Eldersburg, MD (US); Mary Kathryn Hollingsworth, Charlotte, NC (US); Jennifer L. Plese, Shorewood, WI (US); Paul R. Pluger, Denver, NC (US); Steven Everett Sipe, Charlotte, NC (US)

(21) Appl. No.: 16/211,815

(22) Filed: Dec. 6, 2018

Related U.S. Application Data
(60) Provisional application No. 62/608,272, filed on Dec. 20, 2017.

(51) Int. Cl. G06Q 40/02; G06F 16/2457

(52) U.S. Cl. CPC G06Q 40/02; G06F 16/24573

(57) ABSTRACT

Disclosed herein is a method and related system for generating a presentation of a plurality of sequential historical events stored in a service provider system. The method accesses a first historical event from a plurality of historical events associated with a user and stored in a memory of the service provider system. The method further includes locating a first presentation element template associated with the first historical event from a plurality of presentation element templates stored in the memory. The first presentation element template is copied into a first presentation element of a presentation, and data from the first historical event is copied into the first presentation element of the presentation. The method further comprises determining the first historical event as being a negative historical event according to a predefined criteria. The method further comprises transmitting the presentation to a user display device.

### CROSS-REFERENCE TO RELATED APPLICATION

This patent application claims the benefit of U.S. Provisional Patent Application No. 62/608,272, tiled Dec. 20, 2017, which is incorporated by reference herein in its entirety.

### TECHNICAL FIELD

Described herein is a computer-based system that creates a presentation for a sequence of historical events stored in a database.

### BACKGROUND

A user may find value in reviewing a history with an entity comprising a number of events that may involve a relationship with that entity. However, if the number of events is large or the events take place in a complex environment, it may be difficult to appreciate the events collectively in a cohesive manner. It may be advantageous to summarize the events in a cohesive presentation that holistically considers the events.

Such a presentation may be beneficial in a situation where a business entity desires to maintain a relationship with a user. In such a case, it may be important to create the presentation in a manner that emphasizes the positive aspects of the relationship and provides surrounding context to the events so that the presentation provides a view of the relationship in a very palatable manner for the user.

### SUMMARY

Disclosed herein is a computer-implemented method for generating a presentation of a plurality of sequential historical events stored in a service provider system. The method includes using a processor for accessing a first historical event from a plurality of historical events associated with a user and stored in a memory of the service provider system. The method further includes locating a first presentation element template associated with the first historical event from a plurality of presentation element templates stored in the memory. The first presentation element template is copied into a first presentation element of a presentation, and data from the first historical event is copied into the first presentation element of the presentation. The method further comprises determining the first historical event as being a negative historical event according to a predefined criteria. When the first historical event is a negative historical event, the method includes accessing additional data related to the first historical event, and copying the additional data to the first presentation element. The method further comprises transmitting the presentation to a user display device.

Disclosed herein is also a service provider system comprising having a hardware processor and a non-volatile memory-based storage device connected to the hardware processor comprising instructions. The instructions cause the processor to, when executed on the processor, access a first historical event from a plurality of historical events associated with a user and stored in the memory, and locate a first presentation element template associated with the first historical event from a plurality of presentation element templates stored in the memory. The instructions further cause the processor to copy the first presentation element template into a first presentation element of a presentation, copy data from the first historical event into the first presentation element, and determine the first historical event as being a negative historical event according to a predefined criteria. When the first historical event is a negative historical event, the processor accesses additional data related to the first historical event, and copies the additional data to the first presentation element. The processor further transmits the presentation to a user display device.

A non-transitory computer-readable storage medium, is further disclosed, comprising instructions that when executed by a processor, cause the processor to execute the above-described method.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram illustrating an environment within which one implementation of a service provider system described herein may operate, according to an implementation.

FIG. 2 is a block diagram that illustrates components involved in the creating of a presentation from presentation element templates, according to an implementation.

FIG. 3 is a flowchart illustrating an example of a process that may be utilized by the service provider system, according to an implementation.

FIG. 4 is a block diagram illustrating an example of a machine that may he a computer on which various processes described herein may be performed.

FIG. 5 is a block diagram of an example of a distributed computing system within which various processes described herein may be performed.

### DETAILED DESCRIPTION

Described below is a service provider system that creates a presentation for the user for a series of sequential historical events. For the sake of clarity, an example implementation is discussed in which the service provider is a financial planning service provider, the user is a financial services client, the user event history are historical events that relate to the user's financial situation. However, the invention is not limited to this implementation, and the service provider and user event history may relate to any form of a service or any type of system in which user events may be collected.

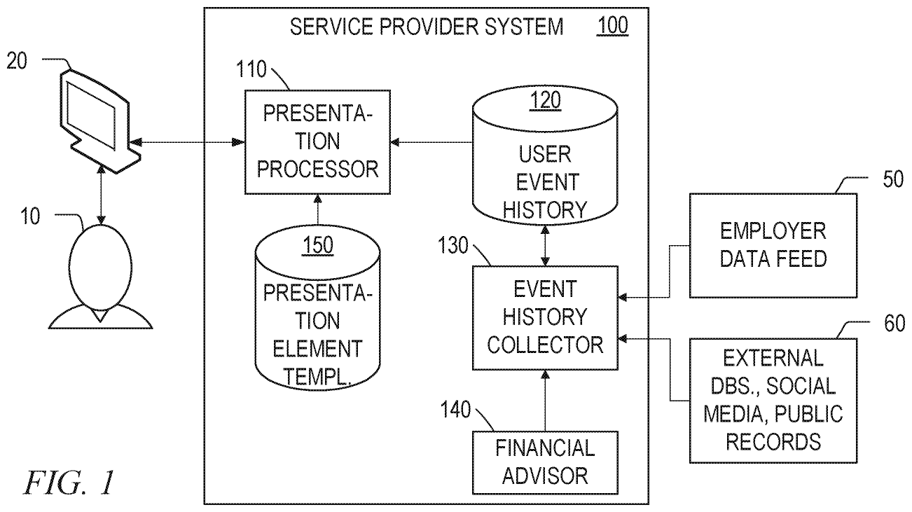

FIG. 1 is a block diagram illustrating one implementation of a service provider system 100 that may be used to create a presentation for a user 10 and provide it on, for example, a display device 20 associated with the user. The example implementation discussed herein is that the service provider system 100 is a system associated with providing financial planning for a user 10 who is a customer.

A main component of the service provider system 100 is the presentation processor 110, which may be used to assemble the presentation based on user events stored in a user event history database 120. Table 1, below, provides a simplified example of events that may be found in the event history database 120.

TABLE 1
Example User Event History Database

| Event | | |
|---|---|---|
| No. | Date | Event Type (with additional data) |
| 1 | 1985 | First job - salary $30K/yr |
| 2 | 1986 | Began saving 6% of salary to 401k |
| 3 | 1988 | Fire - underinsured loss |
| 4 | 1990 | Got married |
| 5 | 1992 | Bought house for $200K |
| 6 | 1995 | First child |
| 7 | 2000 | Received promotion - salary $90K/yr |
| 8 | 2000 | Increased 401k saving to 8% of salary |
| 9 | 2010 | Parents died |
| 10 | 2011 | Received $500K from sale of parents' estate |
| 11 | 2011 | Paid off mortgage |
| 12 | 2011 | Took vacation to Paris |
| 13 | 2011 | Invested $350K of inheritance in mutual funds |
| 14 | 2013 | Received demotion - salary $50K/yr |
| 15 | 2017 | Retired |

The level of detail available may differ—for example, Event #11 may simply contain information related to travel or a vacation, or it may contain more information, such as the fact that this is a dream vacation that has been on the customer's goals for decades. Also, the presentation processor 110 may contain an inference component that determines additional inferred information based on user event history database 120 for some predefined level of certainty. For example, the inference component may determine that Item #10, which only shows up in the user event history database 120 as a large influx of money, is related to Item #9, the parents' death. The inference component may thus determine, with, e.g., an 85% certainty (which may be based, e.g., on an analysis of all historical event data) that this is an inheritance. If a required predefined level of certainty is 50%, then since the inference component determination has a greater certainty (85%), the additional inferred information may be added to the event (i.e., the large income event may be further tagged with the information that this is an inheritance event).

The events may include milestones, such as reaching a first $100K in the user's 10 401k savings plan. In one implementation, such milestones may be determined on the fly by the presentation processor 110 and incorporated into the presentation. For example, the presentation processor 110 may see a $1K 401k deposit event on Dec. 1, 2005, that makes the total 401k value $100,250 and determine milestone data of a first $100K occurring on Dec. 1, 2005, and adding this to the presentation by way of some form of notification, such as an icon, image, graphic, or any of the other presentation elements discussed herein.

The user event history database 120 may be populated with an event history collector 130 that acquires information that may be significant to the user's 10 financial goals and status. It may provide formatting, collect additional information, and perform other processing such that the information in the user event history database 120 is as complete and accurate as possible and possibly to standardize formatting so that similar types of events appear consistent.

In one implementation, the event history collector 130 may receive information from an employer data feed 50 from the user's employer. Typically, employers will have some level of involvement in the employee's savings plan and some relationship with the financial service provider. Thus, information from the employer data feed 50 may provide information relevant to significant events in the user event history database 120, such as raises, bonuses, promotions, moves, significant health events, and changes in family status.

In addition to an employer data feed 50, the event history collector 130 may also obtain and store information from external sources 60, such as external databases, social media, public records, banks and credit card companies, and the like. This information may include changes to the family, significant purchases or windfalls, and the like. The event collector 130 may also obtain information from a financial advisor 140 of the user 10 who may be able to provide significantly more detailed information. For example, a $20K expense may be noted from a bank feed, and credit card receipts may show a large number of purchases being made in Paris, along with airfare to and from Paris. However, the financial advisor 140 may be the one who ties this in with a decades-long goal of the user to travel to Paris with her family. Thus, the events in the user event history database 120 may also incorporate goals (an event type of goal) of the user 10 so that the user's 10 performance against such goals may be tracked. The event history database 120 may include, but is not limited to a salary change, a job change, a family status change, a major purchase, a major income event, a major expense event, a goal establishment event, an entertainment event, or a milestone reached.

The presentation processor 110 may utilize the events in the user event history database 120 to create a presentation for the user 10 that illustrates, in the example implementation, a financial story of the user's financial history. To help illustrate the financial story, the presentation processor 110 may make use of presentation element templates 150, which may include an image, an animation, a video, a virtual reality display element, an augmented reality display element, text, a diagram, and other illustrative devices.

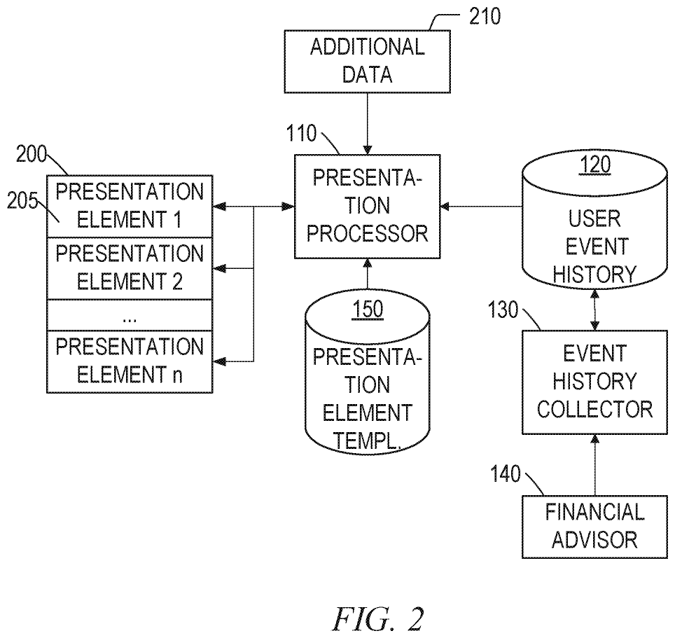

FIG. 2 is a block diagram that illustrates components involved in the creating of a presentation 200 from the presentation element templates 150. The presentation processor 110 locates a presentation element template 150 associated with a user event history element 120 and copies the template to a presentation element 205 of the presentation. The presentation processor 110 may then fill in details of the presentation element 205 with data from the user event history element 120. If the user event history element 120 is a negative element, based on predefined criteria, then additional data 210 may he acquired and added to the presentation element 205. This additional data 210 may be obtained from external sources 60 or internal sources, such as the financial advisor 140 or data sources internal to the service provider system 100, and may be used to explain or provide a positive perspective on the negative user event history element 120. This process may be repeated for the events in the user event history 120, and each presentation element 205 may be stitched together with other presentation elements 205 in order to create a cohesive presentation 200 that may be transmitted to the user.

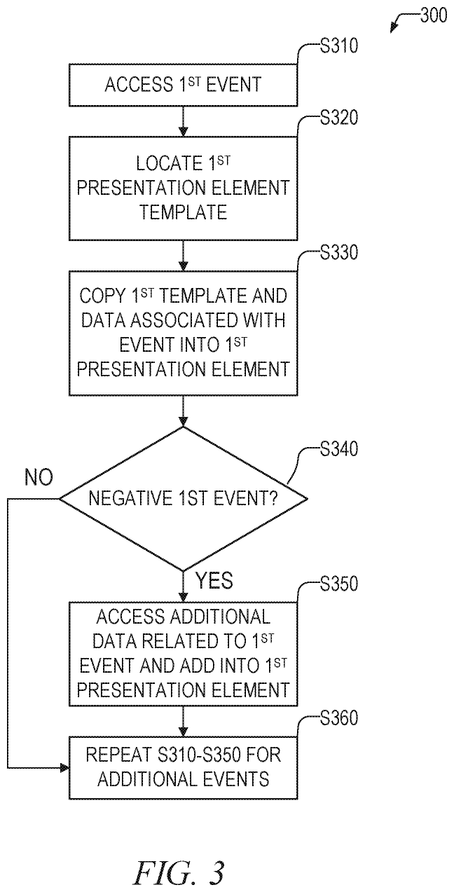

FIG. 3 is a flowchart illustrating an example of a process 300 that may be utilized by the service provider system 100. In operation S310, the presentation processor may access a first historical event from the user event history database 120. By way of example, such an event in the event history database 120 may be the purchase of a house for $200K. (see Event #5 in Table 1, although typically the first historical event would be the first chronological event in the event history database 120). The presentation processor 110 may, at operation S320, locate a “home purchase” presentation element template 150, which may be, for example, a short animation of a family walking into a new home as the “for sale” sign vanishes. The selected presentation element template 150 may be a shell in which specific detailed information may be filled in from the historical event itself. In operation S330, the first historical event information, in the current example, the $200K purchase price along with the mortgage amount and payment schedule) may be combined with the presentation element template 150 and incorporated into the presentation element 205 of the presentation 200 for later possible showing on the display 20 along with the animation.

Later in the presentation, as the presentation processor 110 continues to stitch together the events into the financial story, when the mortgage is finally paid off (see Event #11 in Table 1), a similar animation as shown with respect to Event #5 may be presented, but possibly with an additional celebratory graphic or congratulatory text message, graph, or other imagery/video data.

Explanatory or educational information may be provided with respect to certain events. For example, with Event #5, the presentation may, while noting that having a mortgage may be scary, provide a positive spin by reassuring the user 10 that mortgage interest is deductible on one's income tax and possibly providing a side-by-side comparison of how home buyers have generally had a more positive financial outcome than those who have rented during the same time period.

One aim of presenting the financial story in a positive way, even for negative events and actions, may be to help strengthen a relationship and loyalty between the user 10 and the service provider. To present the financial story in a more positive way, positive events may be highlighted and emphasized, negative events may be downplayed or explained, the user may be congratulated for making “good” financial decisions, and supported or encouraged even when “poor” financial decisions were made.

Certain types of user events in the event history database 120 may be predefined as positive or negative, or the presentation processor 110 may deduce whether an event is positive or negative (or possibly neutral). In some instances, a negative event may have to be deduced on the fly, since additional context may be needed to make the determination. For example, whether a rate of return on a mutual fund of 4% is a positive or a negative event may have to take into account the overall performance of the marketplace.

For events that are negative, that is, an event that is likely to be considered unfavorably by the user 10 or is inconsistent with the user's goals, the presentation processor 110 may take additional steps or incorporate additional information to provide reassurance or some form of a positive perspective on what would otherwise be a negative event. These additional steps or incorporations may take on a variety of forms, such as showing how a seemingly negative course of action outperformed some other course of action. For example, a poorly performing mutual fund that yielded only 2.5% may be shown to outperform having the money in a savings account that essentially pays 0% interest. The chosen course of action may be contrasted with other worse performers or worse options. In another approach, the presentation processor 110 may illustrate how a bad event or decision has been offset by other good events or decisions. Thus, the presentation processor 110 may access external information to locate poorer performing possibilities that may be illustrated to the user 10 in the presentation (such as considering different investments, different time periods for consideration, and so on.

By way of example, in operation S340, the nature of the first event is determined, and when it is a negative first event, based on a predefined criteria (S340:YES), additional data (in operation S350) may be accessed and added into the first presentation element 205. For example, with regard to Event #3—a situation in which the user 10 lost items of considerable value by being underinsured for a fire—the presentation processor 110 may put a positive spin on the event by illustrating that this event encouraged the user 10 to ensure adequate insurance coverage from then afterwards. The presentation processor 110 may the access additional data associated with later purchases of adequate insurance policies and incorporate this additional data into the presentation element.

In another example, Event #14 (demotion and salary reduction), the presentation processor 110 may access additional data containing national salary averages and include this additional data in the presentation element that shows the reduced salary is still well above the national mean salary, that it is not unusual for a person nearing the end of their career to have a reduced income (accessing statistics related to income and career stage), and congratulating the user 10 for their diligent savings over the years to deal with this specific type of situation (accessing information about their current savings value).

When the first event is not negative, (S340:NO), then the process may not have to access additional data as indicated in operation S350 (although the operation is not precluded from accessing additional data that may help bolster positive events). Operation S360 just indicates that the operational elements described above may be repeated for a plurality of events in the user event history database 120.

Thus, the presentation focuses on or emphasizes the good events and milestones and downplays the bad events and milestones (without distorting or rendering inaccurate the overall picture), highlighting the user's 10 good decision-making. The presentation may provide tie-ins with the overall economy (e.g., “your investment in XYZ was down 2.5% in 2008, but the overall economy was in recession that year, and many fund investments were down more than 10%”, or “but you managed to recoup the loss and then some in the following three years”). The presentation may also show averages and a comparison to peers (actual or hypothetical peers, i.e., those who kept their money in savings or money markets, or only put away 5%, while you put away 10%). The service provider system 100 may allow the user to understand how the choices they have made affect where they are at in their plan or indicated goals, and may further project what these choices mean for their long-term plan.

The presentation processor 110 may include an interactive component that permits the user 10 to test out different “what if” scenarios, which may be presented to the user via the presentation processor 110 or requested by the user 10 himself. However, even with the user 10 interacting with the presentation processor 110, the system may still attempt to put a positive spin on the “what if” scenario. For example, if the user 10 requests a comparison based on if he had chosen a top ten highest yielding mutual fund, the presentation processor 110 may show a performance significantly better than what the user 10 actually received. The presentation processor 110 may indicate that only 0.3% of investors chose such well behaving funds, or that investing in those funds in past years resulted in much lower yields.

Positive events may include, but are not limited to, a new job, a raise, an increase in investment value, a market increase, a home or other property purchase, a marriage, a child, and a vacation. Negative events may include a job loss, demotion, or an unfavorable job change, a family member loss, a personal or family illness, a market decrease, and an asset loss.

Generation of the presentation may be provided upon request or triggered by an event. For example, it is not unusual for a user 10 to leave a financial services provider when their position or job with their employer terminates (e.g., through quitting, retirement, or being laid off). By having a detected termination event trigger the generation of the presentation, a strengthening of the relationship between the user 10 and the financial services provider may be achieved right at a point in time when there may likely be a termination of the relationship. The service provider system 100 may, upon determining an occurrence of a termination or impending termination, send out a communication (e.g., an email, web page link, etc.) with the presentation or link that summarizes the relationship.

The service provider system 100 may be utilized to build an on-going relationship with the user 10 by, for example, scheduling periodic check-ins, status updates, and other communications relevant to the user's participation in financial planning. The service provider system 100 may make it attractive for the user to remain in their current financial plan by including other features as well, such as providing an ability to access money with an automated teller machine (ATM) or providing forms of electronic payments. The service provider system may also incorporate a rebalancing feature, or a system that automatically changes the user's 10 glide path as they get closer to retirement and provides a draw-down plan. Also, to the extent that presentations have been prepared over the years prior to retirement, the user 10 may be provided access to all of the presentations once they are about to retire.

### General Computer and Network Architecture

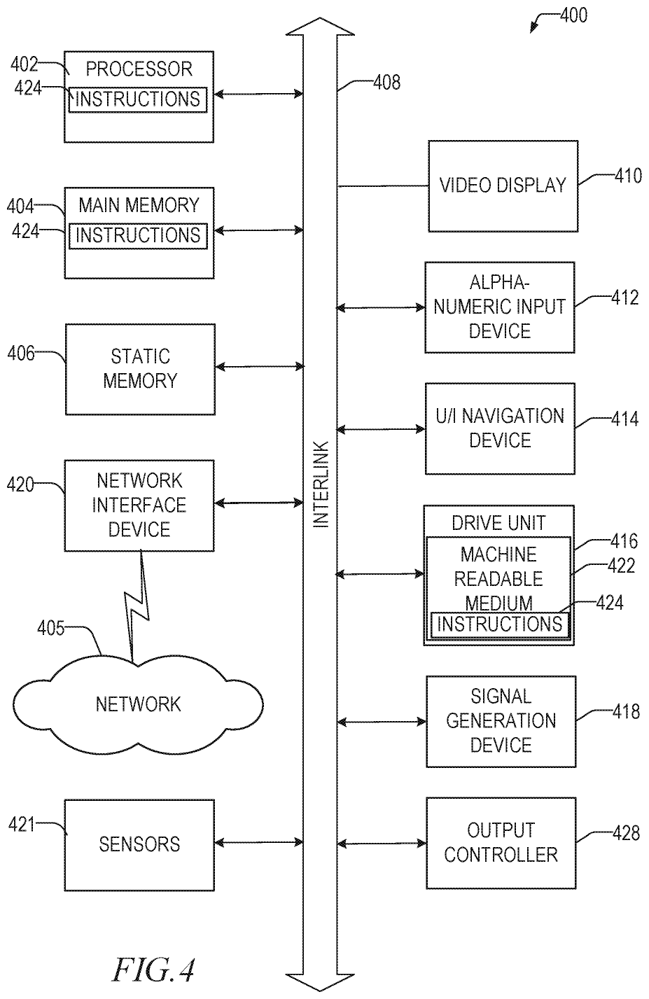

To describe some configurations in greater detail, reference is made to examples of hardware structures and interconnections usable in the designs of the present disclosure. FIG. 4 is a block diagram illustrating a machine 400 that may be a computer or computer system on which various processes described herein may be performed. The machine 400 may form various parts or all of the service provider system 100 described above. Such a machine 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example described herein, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over the communications network 405 using a transmission medium via the network interface device 420. The term “transmission medium” is defined herein to include any medium that is capable of storing, encoding, or carrying instructions for execution by the machine, and includes digital or analog communications signals or other medium to facilitate communication of such software.

The machine 400 may communicate with one or more other machines 400 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 402.11 family of standards known as Wi-Fi®, IEE 402.16 family of standards known as WiMax®), IEEE 402.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 400. In an example, the network interface device 420 may include one or more physical jacks (e.g., Ethernet, coaxial, or phone jacks) or one or more antennas to connect to the communications network 426.

In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

A wide variety of computing devices may constitute a machine 400, as described herein. The following list includes a variety of devices that may fit the definition of a machine 400: a personal data assistant (PDA), a cellular telephone, including a smartphone, a tablet computing device, a laptop computer, a desktop computer, a workstation, a server computer, a mainframe computer, and the like.

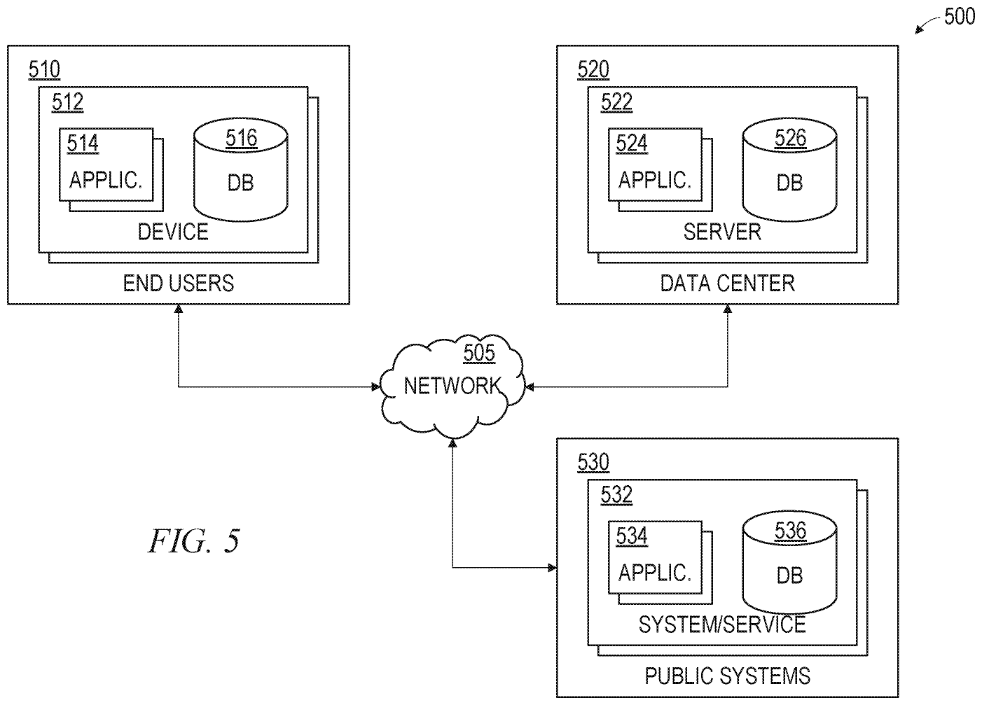

FIG. 5 is a block diagram of a distributed system 500 that may include a client-server architecture or cloud computing system. The system 500 may be a system 100 as described above. Distributed system 500 may have one or more end users 510. An end user 510 may have various computing devices 512, which may be machines 400 as described above. The end-user computing devices 512 may comprise applications 514 that are either designed to execute in a stand-alone manner, or interact with other applications 514 located on the device 512 or accessible via the network 405. These devices 512 may also comprise a data store 516 that holds data locally, the data being potentially accessible by the local applications 514 or by remote applications.

The system 500 may also include one or more data centers 520. A data center 520 may be a server 522 or the like associated with a business entity that an end user 510 may interact with. The business entity may be a computer service provider, as may be the case for a cloud services provider, or it may be a consumer product or service provider, such as a retailer. The data center 520 may comprise one or more applications 524 and databases 526 that are designed to interface with the applications 514 and databases 516 of end-user devices 512. Data centers 520 may represent facilities in different geographic locations where the servers 522 may be located. Each of the servers 522 may be in the form of a machine(s) 300.

The system 500 may also include publicly available systems 530 that comprise various systems or services 532, including applications 534 and their respective databases 536. Such applications 534 may include news and other information feeds, search engines, social media applications, and the like. The systems or services 532 may be provided as comprising a machine(s) 300.

The end-user devices 512, data center servers 522, and public systems or services 532 may he configured to connect with each other via the network 305, and access to the network by machines may be made via a common connection point or different connection points, e.g. a wireless connection point and a wired connection. Any combination of common or different connections points may be present, and any combination of wired and wireless connection points may be present as well. The network 305, end users 510, data centers 520, and public systems 530 may include network hardware such as routers, switches, load balancers and/or other network devices.

Other implementations of the system 500 are also possible. For example, devices other than the client devices 512 and servers 522 shown may be included in the system 500. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 522.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for generating a presentation of a plurality of sequential historical events stored in a service provider system, comprising, using a processor:
gathering data related to a plurality of historical events associated with a user;
formatting the data using a format configured to standardize storage according to an event schema of the plurality of historical events associated with the user;
storing the data in a user-specific database of the service provider system using the format;
accessing a first historical event from the plurality of historical events associated with the user and stored in the user-specific database of the service provider system;
locating a first presentation element template associated with the first historical event from a plurality of presentation element templates stored in the user-specific database;
copying the first presentation element template into a first presentation element of the presentation;
copying data from the first historical event into the first presentation element of the presentation;
determining the first historical event as being a negative historical event according to a predefined criteria including using the processor to evaluate the first historical event;
determining additional inferred information based on data of the first historical event exceeding a predefined percentage level of certainty;
adding the inferred information to the first presentation element;
generating an animation including stitching together presentation elements of at least two of the plurality of historical events, wherein the animation includes at least a portion of the first presentation element and a virtual reality display element;
when the first historical event is the negative historical event:
accessing additional data related to the first historical event, the additional data selected to provide a positive perspective on the negative historical event, including locating at least one possibility to be illustrated to the user;
copying the additional data to the first presentation element;
formatting the first presentation element for a user display device;
transmitting the presentation to the user display device;
displaying the presentation on the user display device, including presenting the animation using the virtual reality display element with graphical highlights to emphasize the positive perspective and explain the negative historical event; and
providing, using the processor, an interactive component on the user display device to receive input from the user related to hypothetical historical events and to provide comparison and perspective for the hypothetical historical events.

2. The method of claim 1, further comprising:
accessing a second historical event from the plurality of historical events;
locating a second presentation element template associated with the second historical event from the plurality of presentation element templates;
copying the second presentation element template into a second presentation element of the presentation;
copying data from the second historical event into the second presentation element; and
stitching the second presentation element to the first presentation element so that it is presented to the user sequentially after the first presentation element.

3. The method of claim 1, wherein the predefined criteria is at least one of a job loss, a demotion, a job change, a family member loss, a personal illness, a family illness, a market decrease, or an asset loss.

4. The method of claim 1, wherein the service provider system is a financial service provider system, and the first historical event is a financial historical event.

5. The method of claim 1, wherein the additional data is at least one of financial norms, alternative investment data, peer group data, and descriptive information.

6. The method of claim 1, wherein the first historical event is at least one of a salary change, a job change, a family status change, a major purchase, a major income event, a major expense event, a goal establishment event, an entertainment event, or a milestone reached.

7. The method of claim 1, further comprising:
initiating a generation of the presentation by a triggering event.

8. The method of claim 7; wherein the triggering event is a user job termination.

9. The method of claim 1, further comprising:
determining milestone data based on the plurality of historical events.

10. The method of claim 9 further comprising:
adding the milestone data into the presentation.

11. The method of claim 1, further comprising:
receiving external financial data related to the user from an employer of the user; and
formatting and storing the external financial data as historical event data in the plurality of historical events.

12. The method of claim 1, further comprising:
receiving advisor financial data related to the user from an advisor of the user; and
formatting and storing the advisor financial data as historical event data in the plurality of historical events.

13. The method of claim 1, wherein the transmitting of the presentation is performed over a network that connects the user to the service provider system.

14. The method of claim 1, wherein the first presentation element template is at least one of an image, an animation, a video, a virtual reality display element, an augmented reality display element, text, or a diagram.

15. A service provider system comprising:
a hardware processor;
a non-volatile memory-based storage device connected to the hardware processor comprising instructions that, when executed on the processor, configure the processor to:
gather data related to a plurality of historical events associated with a user;
format the data using a format configured to standardize storage according to an event schema of the plurality of historical events associated with the user;
store the data in a user-specific database of the service provider system using the format;
access a first historical event from the plurality of historical events associated with the user and stored in the user-specific database;
locate a first presentation element template associated with the first historical event from a plurality of presentation element templates stored in the user-specific database;
copy the first presentation element template into a first presentation element of a presentation;
copy data from the first historical event into the first presentation element;
determine the first historical event as being a negative historical event according to a predefined criteria including using the processor to evaluate the first historical event;
determine additional inferred information based on data of the first historical event exceeding a predefined percentage level of certainty;
add the inferred information to the first presentation element;
generate an animation including stitching together presentation elements of at least two of the plurality of historical events, wherein the animation includes at least a portion of the first presentation element and a virtual reality display element;
when the first historical event is the negative historical event:
access additional data related to the first historical event, the additional data selected to provide a positive perspective on the negative historical event, including locating at least one possibility to be illustrated to the user;
copy the additional data to the first presentation element;
format the first presentation element for a user display device;
transmit the presentation to the user display device;
display the presentation on the user display device, including presenting the animation using the virtual reality display element with graphical highlights to emphasize the positive perspective and explain the negative historical event; and
provide, using the processor, an interactive component on the user display device to receive input from the user related to hypothetical historical events and to provide comparison and perspective for the hypothetical historical events.

16. The system of claim 15, wherein the instructions further configure the processor to:
access a second historical event from the plurality of historical events;
locate a second presentation element template associated with the second historical event from the plurality of presentation element templates;
copy the second presentation element template into a second presentation element of the presentation;
copy data from the second historical event into the second presentation element; and
stitch the second presentation element to the first presentation element so that it is presented to the user sequentially after the first presentation element.

17. The system of claim 15, wherein the instructions further configure the processor to:
receive advisor financial data related to the user from an advisor of the user; and
format and store the advisor financial data as historical event data in the plurality of historical events.

18. The system of claim 15, wherein the instructions further configure the processor to:
receive external financial data related to the user from an employer of the user; and
format and store the external financial data as historical event data in the plurality of historical events.

19. A non-transitory computer-readable storage medium, the computer-readable storage medium including instructions that when executed by a processor, cause the processor to:
gather data related to a plurality of historical events associated with a user;
format the data using a format configured to standardize storage according to an event schema of the plurality of historical events associated with the user;
store the data in a user-specific database using the format;
access a first historical event from the plurality of historical events associated with the user and stored in the user-specific database;
locate a first presentation element template associated with the first historical event from a plurality of presentation element templates stored in the user-specific database;
copy the first presentation element template into a first presentation element of a presentation;
copy data from the first historical event into the first presentation element;
determine the first historical event as being a negative historical event according to a predefined criteria including using the processor to evaluate the first historical event;
determine additional inferred information based on data of the first historical event exceeding a predefined percentage level of certainty;
add the inferred information to the first presentation element;
generate an animation including stitching together presentation elements of at least two of the plurality of historical events; wherein the animation includes at least a portion of the first presentation element and a virtual reality display element;
when the first historical event is the negative historical event:
access additional data related to the first historical event, the additional data selected to provide a positive perspective on the negative historical event, including locating at least one possibility to be illustrated to the user;
copy the additional data to the first presentation element;
format the first presentation element for a user display device;
transmit the presentation to the user display device;
display the presentation on the user display device, including presenting the animation using the virtual reality display element with graphical highlights to emphasize the positive perspective and explain the negative historical event; and
provide, using the processor, an interactive component on the user display device to receive input from the user related to hypothetical historical events and to provide comparison and perspective for the hypothetical historical events.

20. The storage medium of claim 19, wherein the instructions further cause the processor to:
access a second historical event from the plurality of historical events;
locate a second presentation element template associated with the second historical event from the plurality of presentation element templates;
copy the second presentation element template into a second presentation element of the presentation;
copy data from the second historical event into the second presentation element; and
stitch the second presentation element to the first presentation element so that it is presented to the user sequentially after the first presentation element.
